(19) United States
(12) Patent Application Publication
(10) Pub. No.: US 2010/0246547 A1
(43) Pub. Date: Sep. 30, 2010

(54) ANTENNA SELECTING APPARATUS AND METHOD IN WIRELESS COMMUNICATION SYSTEM

(75) Inventor: Young-Suk YOON, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/730,306

(22) Filed: Mar. 24, 2010

(30) Foreign Application Priority Data
Mar. 26, 2009 (KR) 10-2009-0026072

(51) Int. Cl. H04W 40/00

(52) U.S. Cl. 370/338

(57) ABSTRACT

Provided is a reception antenna selecting method of a receiver including a plurality of antennas in a wireless communication system. The reception antenna selecting method aligns amplified frames according to levels of received signals and performs CRC for each of the aligned frames.

### CLAIM OF PRIORITY

This application claims priority under 35 U.S.C. §119 to an application filed in the Korean Intellectual Property Office on Mar. 26, 2009 and assigned Serial No. 10-2009-0026072, the contents of which are incorporated herein by reference.

### BACKGROUND OF THE INVENTION

1. Field of the Invention

The present invention relates generally to an antenna selecting apparatus and method, which improve reliability as well as performance and remove the effect of an interference signal through beam forming and Cyclic Redundancy Check (CRC) in a wireless communication system.

2. Description of the Related Art

In a wireless communication environment, since an Industrial Scientific Medical (ISM) frequency band is a domain that is shared by a wireless Local Area Network (LAN) and other application devices, the performance of an Access Point (AP) may deteriorate by interference from nearby, similar systems. As such, minimizing the interference is one of major issues in the wireless LAN.

The existing access point uses a Received Signal Strength Indication (RSSI) determination scheme that simply determines the power of a signal received through multi-antennas to select a strongest signal. Briefly, the RSSI determination scheme determines signals that are received by respective array antennas over a wireless section, selects a strongest signal from among the determined signals, decodes the selected signal through a modem, and processes the data of a desired signal through CRC. In operation, the RSSI determination scheme decodes the interference signal and performs CRC. Accordingly, an access point may discover that the decoded signal is not the desired signal, only after CRC. This requires that the access point requests retransmission. As a result, unnecessary time, computing, and memory usage occurs due to such errors.

### SUMMARY OF THE INVENTION

The present invention is to substantially solve at least the above problems and/or disadvantages and to provide at least the advantages below. Accordingly, the present invention provides an antenna selecting apparatus and its processing method in a wireless communication system.

Another aspect of the present invention is to provide an antenna selecting apparatus and method, which prevent resources from being wasted due to the reception of an undesired signal by applying a switch algorithm to a modem and improving the performance of modem processing through a beam forming array antenna, thus enhancing reliability for signal selection in a wireless communication system.

According to an aspect of the present invention, a reception antenna selecting method is provided for a receiver having a plurality of antennas in a wireless communication system. The inventive method includes: aligning amplified frames according to strength levels of received signals; and performing Cyclic Redundancy Check (CRC) for each of the aligned frames.

According to another aspect of the present invention, a reception antenna selecting apparatus of a receiver having a plurality of antennas in a wireless communication system includes: a correlation value-based antenna aligner aligning amplified frames according to strength levels of received signals; and a CRC determiner performing CRC for each of the aligned frames.

According to another aspect of the invention, an access point includes: a network interface for communicating with at least one wide area network; a plurality of antennas for amplifying a plurality of frames from a plurality of client devices over the wireless link; a processor for aligning the amplified frames according to strength levels of received signals, for performing CRC for each of the aligned frames, and for determining the reception antenna based on a reception characteristic of a frame that shows correlation values corresponding to the highest strength level.

### BRIEF DESCRIPTION OF THE DRAWINGS

The above and features and advantages of the present invention will become more apparent to those skilled in the art from the following detailed description when taken in conjunction with the accompanying drawings in which:

FIG. 1 is a diagram illustrating a frame structure in an Institute of Electrical and Electronics Engineers (IEEE) 802.11 Wireless LAN (WLAN) according to an exemplary embodiment of the present invention;

FIG. 2 is a diagram illustrating the reception block configuration of an access point according to an exemplary embodiment of the present invention;

FIG. 3 is a diagram illustrating the block configuration of a preprocessor according to an exemplary embodiment of the present invention;

FIG. 4 is a flowchart illustrating the operation of an access point according to an exemplary embodiment of the present invention;

FIG. 5A is a diagram illustrating performance when the existing method is used;

FIG. 5B is a diagram illustrating performance according to an exemplary embodiment of the present invention;

FIG. 6A is a diagram illustrating the existing frame error rate;

FIG. 6B is a diagram illustrating a frame error rate according to an exemplary embodiment of the present invention; and

FIG. 7 is a diagram illustrating an antenna pattern according to an exemplary embodiment of the present invention.

### DETAILED DESCRIPTION OF THE INVENTION

Preferred embodiments of the present invention will be described herein below with reference to the accompanying drawings. For the purposes of clarity and simplicity, detailed descriptions related to well-known functions or configurations will be omitted in order not to unnecessarily obscure subject matters of the present invention.

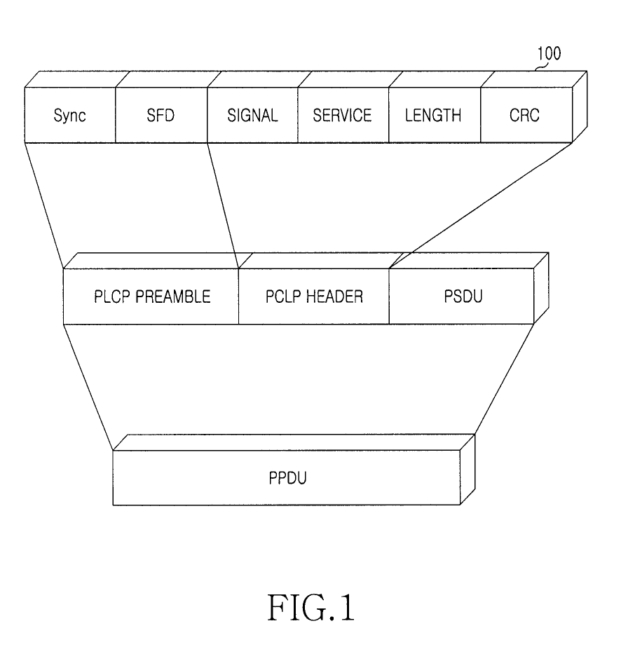

FIG. 1 is a diagram illustrating a frame structure specified in an Institute of Electrical and Electronics Engineers (IEEE) 802.11 Wireless LAN (WLAN) to which the teachings of the present invention is applicable. Note that wireless communication standards include, but are not limited to IEEE 802.11, Bluetooth, advanced mobile phone services (AMPS), digital AMPS, global system for mobile communications (GSM), code division multiple access (CDMA), wireless application protocols (WAP), local multi-point distribution services (LMDS), multi-channel multi-point distribution systems (MMDS), and/or variations thereof.

Referring to FIG. 1, an access point according to an exemplary embodiment of the present invention uses an IEEE 802.11 protocol, which includes a plurality of client devices that communicate over a wireless link with one or more access points. The transmitting device (e.g., a client device or access point) transmits at a fixed power level regardless of the distance between the transmitting device and a targeted device (e.g., station or access point. In operation, wireless transmission may include some error.

Access point assesses signals received from the plurality of client devices based upon a signal strength criteria such as RSSI of data received from the particular client device. The access point receives reception characteristics generated by the various client devices based on normal, ongoing packets exchanges with the access point. For example, reception characteristics might comprise an error detecting code with Cyclic Redundancy Check (CRC) bit. Thus, a signal suitable for the access point is normal as the CRC result of a received signal, and a signal unsuitable for the access point is abnormal as the CRC result of the received signal. Hereinafter, a signal is referred to as a frame.

Accordingly, the antenna selecting apparatus according to an exemplary embodiment of the present invention first searches a Physical Layer Convergence Protocol (PLCP) preamble in the frame structure, determines the location of CRC in the searched PLCP preamble, and loads a CRC data 100 in the determined location of CRC to perform CRC.

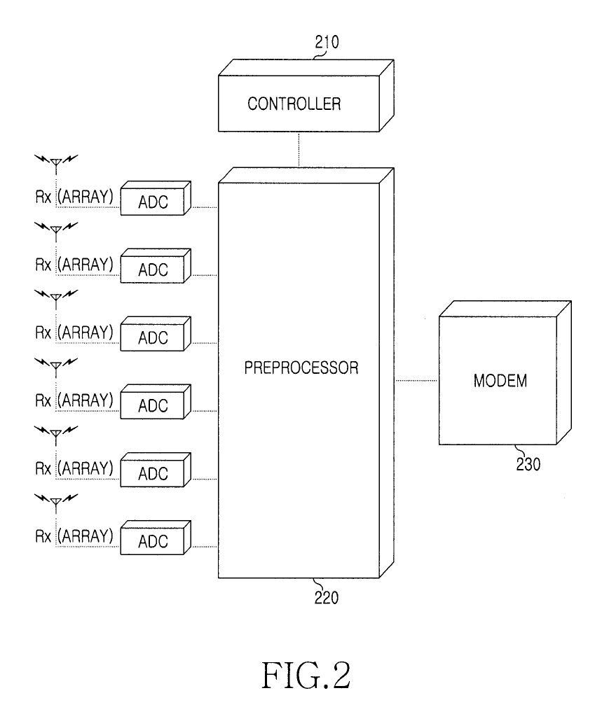

FIG. 2 is a diagram illustrating the reception block configuration of an access point according to an exemplary embodiment of the present invention.

Referring to FIG. 2, an access point according to an exemplary embodiment of the present invention includes a plurality of antennas, a plurality of analog-to-digital converters (ADCs), a preprocessor 220, a controller 210, and a modem 230. Herein, the plurality of antennas perform amplification at an amplification rate “A(Θ)” (where Θ is a reception angle). Although a limited number of antennas is shown in FIG. 2 for illustrative purposes, it is to be understood that the WLAN can support concurrent communications between a much less or larger number of antennas. Thus, the number of antennas and its associated modules in the drawing should not impose limitations on the scope of the invention. In operation, a frame received through the plurality of antennas is amplified at an amplification rate (i.e., the frame is amplified in accordance with an antenna pattern size), and analog-to-digital converted and then inputted to the preprocessor 220.

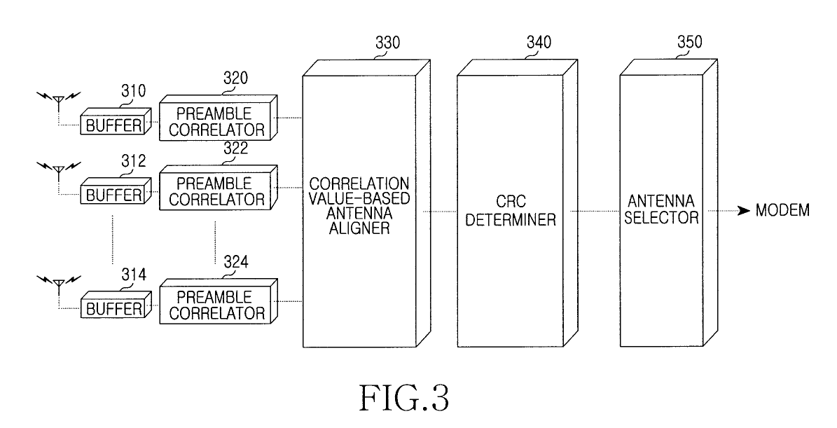

The preprocessor 220 first searches a PLCP preamble in the received frame, searches the location of CRC based on the searched location of PLCP preamble, and acquires a CRC data in the searched CRC location to perform CRC. The preprocessor 220 selects an antenna to use for reception when the CRC result is normal. A detail description of antenna selection is described later with reference to FIG. 3. The preprocessor 220 informs the controller 210 of the antenna selection result.

The controller 210 controls the overall operation of a receiver. Particularly, the controller 210 controls the preprocessor 220 and the modem 230.

In particular, when the controller 210 receives the antenna selection result from the preprocessor 220, it allows the modem 230 to perform another reception operation.

A control command transfer path from the controller 210 may be transferred to the modem 230 through the preprocessor 220. Alternatively, the controller 210 may perform the function of the preprocessor 220. Thus, when actually implementing a product, the controller 210 may be configured to perform all the functions of the preprocessor 220, or it may be configured to perform only a portion of the functions of the preprocessor 220. Although not shown, a separate transfer path may exist. The detailed operation of the preprocessor 220 will be described below.

FIG. 3 is a diagram illustrating the block configuration of a preprocessor according to an exemplary embodiment of the present invention.

Referring to FIG. 3, a preprocessor 20 according to an exemplary embodiment of the present invention performs an antenna selection function and CRC for a received frame. The preprocessor 20 includes buffers 310, 312 and 314, preamble correlators 320, 322 and 324, a correlation value-based antenna aligner 330, a CRC determiner 340, and an antenna selector 350.

Frames, which are respectively received through antennas and are amplified at an amplification rate based on a reception angle, are respectively stored in the buffers 310, 312 and 314 through analog-to-digital conversion operations and then respectively inputted to the preamble correlators 320, 322 and 324.

The preamble correlators 320, 322 and 324 respectively search the locations of PLCP preambles in the received frames, and provide the received frames to the correlation value-based antenna aligner 330. The preamble correlators 320, 322 and 324 determine or obtain the PLCP preambles in the received frames.

The correlation value-based antenna aligner 330 aligns the received frames according to the strength level order of received signals and provides the aligned frames to the CRC determiner 340. In this case, the received frame with the highest strength level may be provided firstly.

The CRC determiner 340 performs CRC for each of the frames in the aligned order. A frame suitable for the access point is normal as the CRC result, and a frame unsuitable for the access point is abnormal as the CRC result. The CRC determiner 340 may performs CRC because the CRC determiner 340 may determines location of each CRC and may obtain each CRC data in the frames.

The CRC determiner 340 provides the CRC results to the antenna selector 350.

The antenna selector 350 searches and determines frames showing a normal checked result from among the provided CRC results. The antenna selector 350 then selects one antenna with highest strength level among antennas that has received the determined frames showing the normal checked result.

Subsequently, the received frame is provided to the modem 230 through the selected antenna. This operation is repeated for each frame.

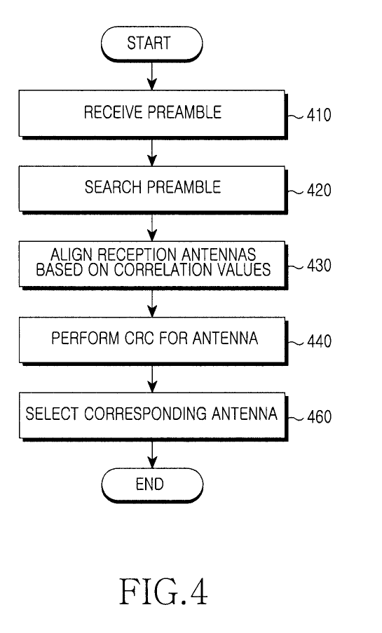

FIG. 4 is a flowchart illustrating the operation of an access point according to an exemplary embodiment of the present invention.

Referring to FIG. 4, when frames are received through a plurality of antennas, the frames are amplified at an amplification rate and then go through analog-to-digital conversion in step 410. The preamble correlators that are included in the respective antennas search PLCP preambles in the received frames to find the locations of the PLCP preambles, respectively in step 420.

Subsequently, the correlation value-based antenna aligner aligns the frames, according to strength level, which are received through the antennas and the correlation value-based antenna aligner aligns the frames according to the strength level of received signals in step 430.

The CRC determiner performs CRC for each of the frames in the aligned order in step 440. A frame suitable for the access point is normal as the CRC result, and a frame unsuitable for the access point is abnormal as the CRC result.

The antenna selector searches and determines a frame showing a normal checked result from among the provided CRC results. Subsequently, the antenna selector selects an antenna, which has received the determined frame, as a reception antenna in step 460.

In this operation, a CRC operation may be performed for all the frames that have been received through the antennas, and it may be repeated until the first frame showing a normal CRC is found. Moreover, the CRC operation may be performed by the number of specific times (for example, three times).

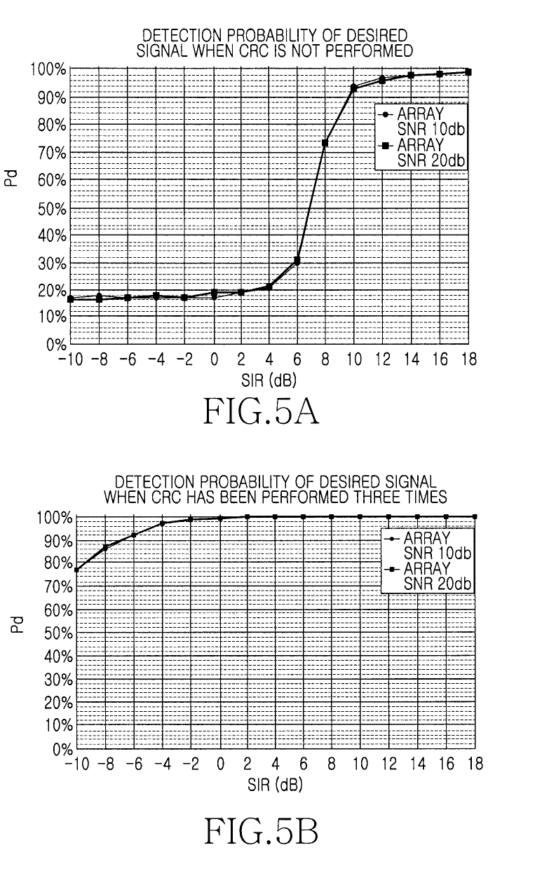

FIG. 5A is a diagram illustrating performance when the conventional method is used. FIG. 5B is a diagram illustrating performance according to an exemplary embodiment of the present invention.

Referring to FIGS. 5A and 5B, it can be seen that the reception probability when using a preprocessing scheme (FIG. 5B) is higher than the conventional reception probability in FIG. 5A, and shows 99% or higher reliability.

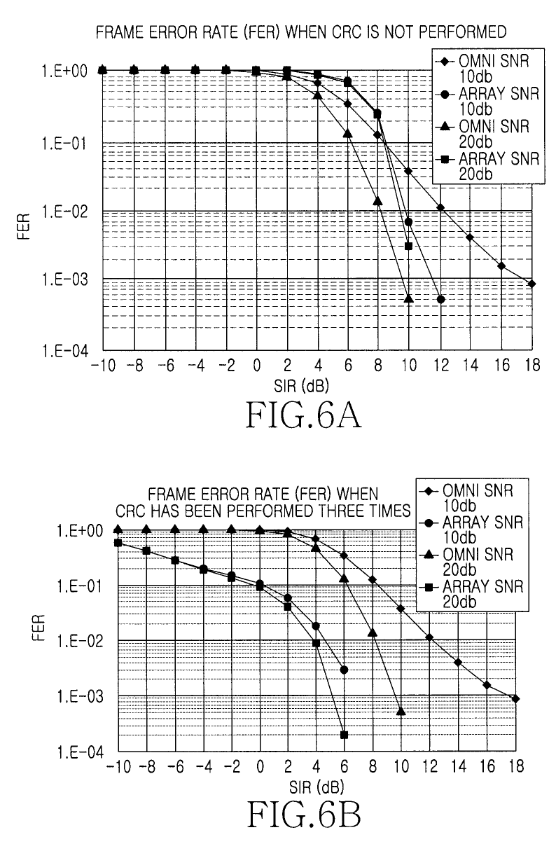

FIG. 6A is a diagram illustrating the conventional frame error rate. FIG. 6B is a diagram illustrating a frame error rate according to an exemplary embodiment of the present invention.

Referring to FIGS. 6A and 6B and comparing frame error rates in the same Signal to Noise Ratio (SNR), it can be seen that the frame error rate of the antenna selecting method according to an exemplary embodiment of the present invention (see FIG. 6B) is lower than the conventional frame error rate (see FIG. 6A).

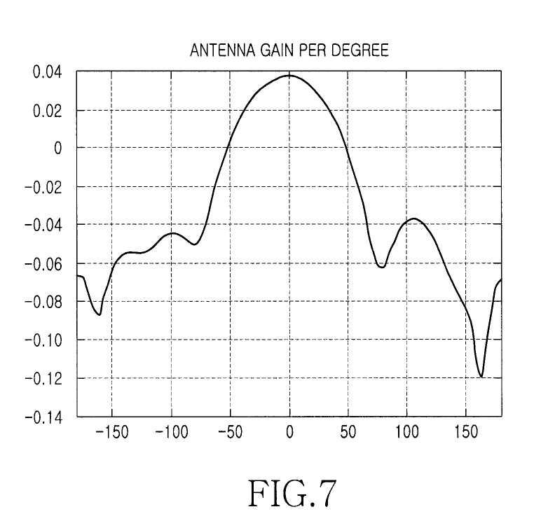

Referring to FIG. 7, a desired signal and an interference signal are received by the six array antennas of an access point in all directions over a wireless path. As is apparent from the foregoing, the antenna selecting apparatus and method according to an exemplary embodiment of the present invention prevent resources from being wasted due to the reception of an undesired signal, by applying a switch algorithm to a modem, thus improving the performance of modem processing through a beam forming array antenna and enhancing reliability for signal selection in the wireless communication system.

Note that the functions of the various elements shown in the Figures, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of selecting a reception antenna of a receiver having a plurality of antennas in a wireless communication system, the method comprising:
receiving a plurality of frames via the plurality of antennas;
amplifying each frame at a predetermined amplification rate based on respective reception angle of the plurality of antennas;
aligning amplified frames according to strength levels of received signals; and
performing Cyclic Redundancy Check (CRC) for each of the aligned frames.

2. The method of claim 1, further comprising: before aligning the amplified frames,
searching locations of preambles in the amplified frames.

3. The method of claim 1, further comprising: selecting a first antenna that received a frame showing a normal CRC as the reception antenna.

4. The method of claim 1, further comprising: selecting an antenna that has a received signal having the highest strength level among the plurality of antennas that received frames showing normal CRC, as the reception antenna.

5. The method of claim 1, wherein performing the CRC comprises:
searching a location of CRC based on the location of the preamble;
acquiring a CRC data in the searched location of CRC; and
performing the CRC for the acquired CRC data.

6. An apparatus for selecting a reception antenna of a receiver in a wireless communication system, comprising:
a plurality of antennas for amplifying a plurality of frames at a predetermined amplification rate based on respective reception angle of the plurality of antennas; a correlation value-based antenna aligner for aligning the amplified frames according to levels of received signals; and
a Cyclic Redundancy Check (CRC) checker for performing CRC for each of the aligned frames.

7. The apparatus of claim 6, further comprising:
a preamble correlator for searching locations of preambles in the amplified frames.

8. The apparatus of claim 6, further comprising: a first antenna selector for selecting a first antenna that received a frame showing a normal CRC, as the reception antenna.

9. The apparatus of claim 6, further comprising: a second antenna selector selecting an antenna that has a received signal having the highest strength level among the plurality of antennas that received frames showing a normal CRC as the reception antenna.

10. The apparatus of claim 7, wherein the CRC determiner searches a location of CRC based on the location of the preamble, acquires a CRC data in the searched location of CRC, and performs the CRC for the CRC data.

11. An access point comprising:
a network interface for communicating with at least one wide area network;
a plurality of antennas for amplifying a plurality of frames from a plurality of client devices over the wireless link;
a processor for aligning the amplified frames according to strength levels of received signals, for performing CRC for each of the aligned frames, and for determining the reception antenna based on a reception characteristic of a frame that shows correlation values corresponding to the highest strength level.

12. The access point of claim 11, wherein the processor further searches locations of preambles in the amplified frames.

13. The access point of claim 12, wherein the processor further searches a location of CRC based on the location of the preamble, acquires a CRC data in the searched location of CRC, and performs the CRC for the CRC data.
